(19) United States
(12) Patent Application Publication
(10) Pub. No.: US 2010/0306653 A1
(43) Pub. Date: Dec. 2, 2010

(54) NETWORK-BASED MULTIMEDIA PLAY METHOD AND COMPUTER READABLE STORAGE MEDIUM AND COMPUTER PROGRAM PRODUCT THEREOF

(75) Inventors: Houng-Jyh Wang, Taipei City (TW); Jian-Yu Ha, Taichung County (TW)

Correspondence Address: RABIN & Berdo, PC, 1101 14TH STREET, NW, SUITE 500, WASHINGTON, DC, 20005, US

(73) Assignee: TECO ELECTRIC & MACHINERY CO., LTD., Taipei (TW)

(21) Appl. No.: 12/611,971

(22) Filed: Nov. 4, 2009

(30) Foreign Application Priority Data
May 27, 2009 (TW) 098117675

(51) Int. Cl. G06F 3/00

(52) U.S. Cl. 715/716

(57) ABSTRACT

A network-based multimedia play method is provided for playing a number of programs. The method includes the following steps. First, a source code of a multimedia webpage is obtained. Next, the source code of the webpage is parsed to obtain a number of program titles and a number of corresponding program website addresses. Then, at least one corresponding file link is obtained according to each program website address, wherein each file link is an access link of a multimedia file. Afterwards, a play list is generated according to each program title and the at least one corresponding file link of each program title. Then, the programs are played according to the play list, wherein each program corresponds to at least one multimedia files over a network.

This application claims the benefit of Taiwan application Serial No. 98117675, filed May 27, 2009, the subject matter of which is incorporated herein by reference.

### BACKGROUND OF THE DISCLOSURE

1. Technical Field

The disclosure relates in general to a network-based multimedia play method and computer readable storage medium and computer program product thereof, and more particularly to a network-based multimedia play method and computer readable storage medium and computer program product thereof for displaying a number of programs.

2. Description of the Related Art

With the rapid growth of accessible information and the popularization made in international network, versatile and diverse multimedia files are available over a network. For example, a website of “youtube” is one which provides a number of multimedia files.

Moreover, multimedia files are further classified in some websites, which is convenient for a user to select desired multimedia files. Taking the website of youtube as an example, a large amount of data files are classified into different categories, such as technology, comedy, education, sport, or news. In this regard, the user can select one from the categories at his/her will or pleasure while visiting the website of youtube. For example, if the user intends to watch news, he/she can select the classification of news to obtain a number of multimedia files which are categorized as the selected classification and related to news. As such, the user can select one of the multimedia files for playing, and watch the obtained piece of news.

However, for a general computer system, when the user visits the mentioned website or the like, he/she needs to use a mouse to select a desired multimedia file. Moreover, after the selected multimedia file has been played, the user needs to select another desired multimedia to play, thereby causing inconvenient to the user.

### SUMMARY OF THE DISCLOSURE

The disclosure is directed to a network-based multimedia play method and computer readable storage medium and computer program product thereof, which generate a play list according to a multimedia webpage containing a number of programs, and determine how to play a number of multimedia files corresponding to the programs according to the play list. In this way, if a multimedia file has been played, another multimedia file is played subsequently, thereby providing a series of programs belonging to the same category for a user, and increasing the convenience for the user.

According to an aspect of the present disclosure, a network-based multimedia play method for playing a number of programs is provided. The method comprises the following steps. First, a source code of a multimedia webpage is obtained. Then, the source code of the multimedia webpage is parsed to obtain a number of program titles and a number of corresponding program website addresses. Next, at least one corresponding file link is obtained according to each program website address, wherein each file link is an access link of a multimedia file. Afterwards, a play list is generated according to each program title and the at least one corresponding file link of each program title. Following that, the programs are played according to the play list, wherein each program corresponds to at least one multimedia files over a network.

According to another aspect of the present disclosure, a computer readable storage medium is provided for storing a plurality of computer instructions. When an electronic device executes the computer instructions, the electronic device performs the network-based multimedia play method mentioned.

According to another aspect of the present disclosure, a computer readable storage medium is provided, which is for performing a network-based multimedia play method in an electronic device having a buffer memory. When the electronic device performs the network-based multimedia play method mentioned when the electronic device loads and executes the computer program product.

The disclosure will become apparent from the following detailed description of the preferred but non-limiting embodiments. The following description is made with reference to the accompanying drawings.

### BRIEF DESCRIPTION OF THE DRAWINGS

FIG. 1 is a flowchart showing a network-based multimedia play method according to an embodiment of this invention.

FIG. 2 is a schematic diagram showing an example of a multimedia webpage displayed by a browser.

FIG. 3 is a schematic diagram showing a portion of source code of the multimedia webpage in FIG. 2 displayed by a text editing program.

FIG. 4 is a schematic diagram showing an example of a program webpage displayed by a browser.

FIG. 5 is a schematic diagram showing an example in which a predetermined website provides a predetermined webpage after decoding the program website address in FIG. 4.

FIG. 6 shows an example of the play list which is generated according to an embodiment of this invention.

### DETAILED DESCRIPTION OF THE DISCLOSURE

An embodiment of this invention provides a network-based multimedia play method for playing a number of programs. The programs each correspond to a number of multimedia files over on a network. Specifically, the network-based multimedia play method generates a play list according to a multimedia webpage containing a number of programs, and determines how to play a number of multimedia files corresponding to the programs according to the play list. Preferably, in an embodiment, the multimedia files corresponding to the programs are played sequentially according to the play list. As such, if a multimedia file has been played, this embodiment plays another multimedia file subsequently, thereby providing a series of programs belonging to the same category for a user, and increasing the convenience for the user.

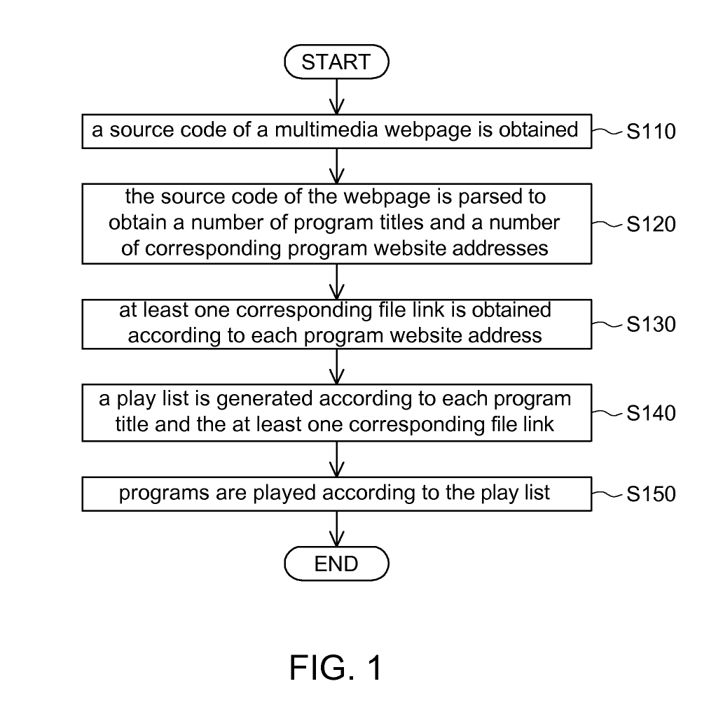

FIG. 1 is a flowchart showing a network-based multimedia play method according to an embodiment of this invention. The method includes the following steps.

First, as shown in step S110, a source code of a multimedia webpage is obtained. Next, as shown in step S120, the source code of the webpage is parsed to obtain a number of program titles and a number of corresponding program website addresses. Then, as shown in step S130, at least one corresponding file link is obtained according to each program website address, wherein each file link is an access link of a multimedia file.

Afterwards, as shown in step S140, a play list is generated according to each program title and the at least one corresponding file link of each program title. Then, as shown in step S150, programs are played according to the play list, wherein each program corresponds to at least one multimedia files over the network.

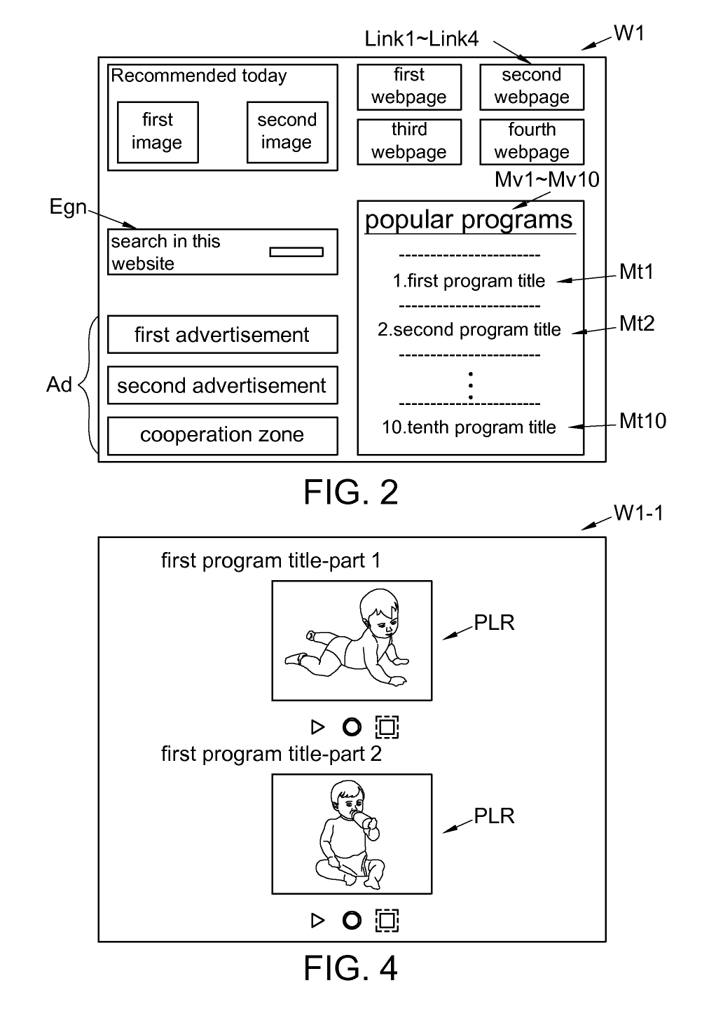

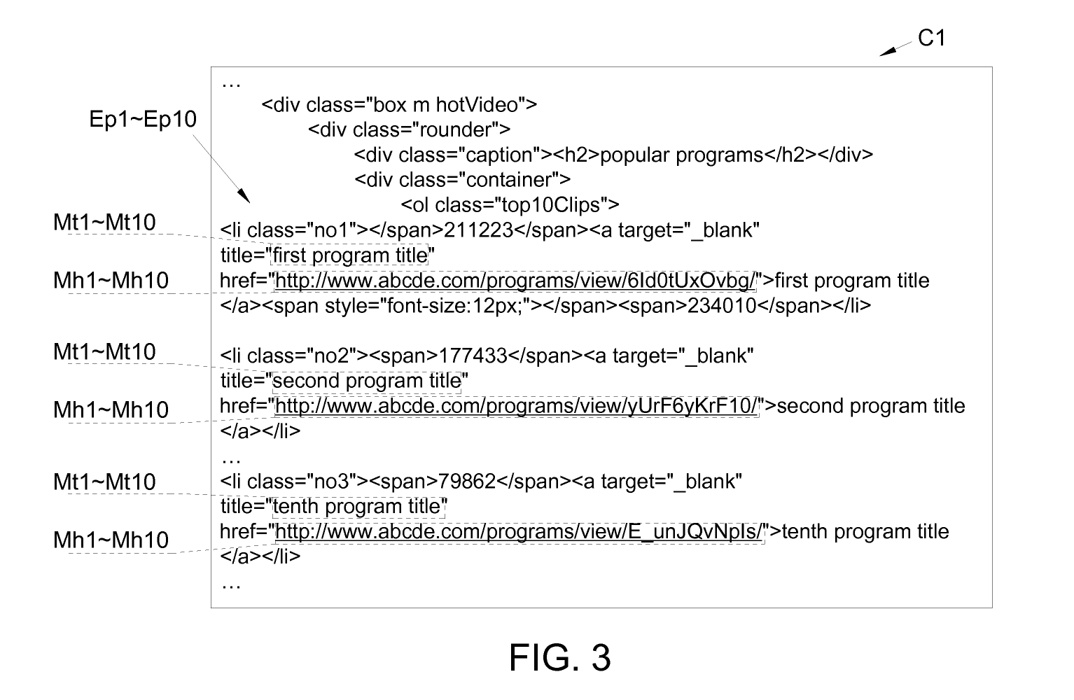

Detailed description for the network-based multimedia play method in FIG. 1 is elaborated below for illustration with reference to FIGS. 1-3. FIG. 2 is a schematic diagram showing an example of a multimedia webpage W1 displayed by a browser, and FIG. 3 is a schematic diagram showing a portion of source code C1 of the multimedia webpage W1 in FIG. 2 displayed by a text editing program.

In the step S110, source code C1 of the multimedia webpage W1 is obtained. The multimedia webpage W1 includes, for example, a number of programs. The program herein includes, for example, video multimedia files or audio multimedia files. The video multimedia files include, for example, video and audio streaming files. The audio multimedia files include, for example, audio streaming files from radio, speech, or news. However, this invention is not limited thereto. The programs herein include any types of accessible files over a network. In this embodiment, the multimedia webpage W1 is exemplified as including ten popular movie programs Mv1-Mv10, and their program titles Mt1-Mt10 are displayed to serve as corresponding links, as shown in FIG. 2.

The multimedia webpage W1 in FIG. 2 can be displayed by a browser of a compute system, and the portion of source code C1 of the multimedia webpage W1 in FIG. 3 can be displayed by a text editing program. The source code C1 should be programmed with any types of programming language for building webpage. As for the multimedia webpage W1, every object displayed by the browser has a corresponding editing paragraph in the source code C1. In this embodiment, corresponding to the ten popular movie programs Mv1-Mv10 shown in FIG. 2, ten editing paragraphs Ep1-Ep10 can be identified in the source code C1, some of them being shown in FIG. 3.

Next, in the step S120, the source code C1 of the webpage is parsed to obtain a number of program titles and a number of corresponding program website addresses. As shown in FIG. 2, the multimedia webpage W1 not only includes the movie programs Mv1-Mv10, but also includes lots of information, such as a number of links Link1-Link4 for other webpages, a search engine Egn, or advertisements and collaboration zone Ad. In this regard, when parsing the source code C1 of the webpage W1, this embodiment, for example, fetches relative information of the movie programs Mv1-Mv10 by comparing strings of the source code C1. The relative information can be, for example, program titles Mt1-Mt10 and program website addresses Mh1-Mh10 of the movie programs Mv1-Mv10.

Applicant found that some keywords may be identified with high occurrence in the source code C1, and they are related to the program website addresses Mh1-Mh10 of the movie programs Mv1-Mv10. Thus, this embodiment can first parse the source code C1 of the webpage W1 according to the keywords. For example, as shown in FIG. 3, the program website addresses Mh1-Mh10 of the movie programs Mv1-Mv10 both contain the same string, such as “www.abcde.com/programs”, so that this embodiment can serve this string as the keyword for parsing. Then, the parsed is the string in certain fields, such as in the filed of “title”, for identifying the program titles Mt1-Mt10 from the neighborhood of the identified keywords. Similarly, the parsed is the string in certain fields, such as in the filed of “href”, for identifying complete program website addresses Mh1-Mh10 therefrom. This embodiment can also use other kinds of keyword for parsing. Any approach is regarded as a practicable embodiment as long as it obtains the program titles and the corresponding program webpage addresses by parsing the source code C1.

Then, as shown in the step S130, at least one corresponding file link is obtained according to each program website address, wherein each file link is an access link of a multimedia file. An example is made with reference to the program website address Mh1 of the movie program Mv1 in FIG. 3. The program website address Mh1 links to the program webpage W1-1 as shown in FIG. 4. When linking to the program webpage W1-1 of the move program Mv1, source code of the program webpage W1-1 may contain file links of a number of multimedia files of the movie program Mv1. Meanwhile, the file links can be used to access the multimedia files. For example, the file links can be used to play the multimedia files of the movie program Mv1 by a media player PLR.

However, in order to prevent webpage's content from being abused, webpage addresses may be encoded by many network practitioners. Assume that the website addresses Mh1 has been encoded. In this situation, if the webpage W1-1 is not decoded, the source code of the webpage W1-1 may appear as jumbled code, so that the real link of the files can not be obtained. In this regard, when at least one corresponding file link is obtained according to each of the program website addresses Mh1-Mh10, an embodiment can decode one program website address previously.

For example, when decoding the program website address Mh1, the program website address Mh1 can be transferred to a predetermined website. Such a predetermined website can be used to decode one program website address, thus providing corresponding file links. In practice, Applicant found that the mentioned predetermined website can be, for example, but non-limitedly, a website of “flvcd” which is addressed as http://www.flvcd.com/, or a website of “flvxz” which is addressed as http://www.flvxz.com/. However, the predetermined website applied in this embodiment is not limited to. Any website capable of decoding one program website address and generating the corresponding file links is regarded as the predetermined website of this embodiment. Besides, in another embodiment, a decode program can also be used to decode the program website address to obtain the corresponding file links.

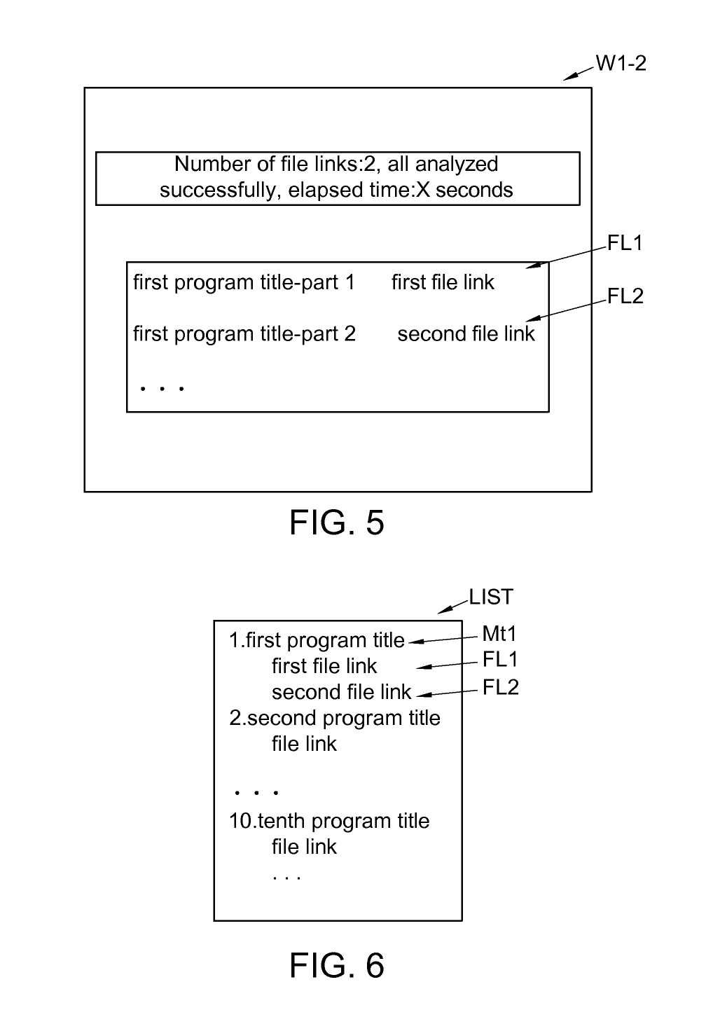

FIG. 5 is a schematic diagram showing an example in which a predetermined website provides a predetermined webpage after decoding the program website address Wh1 in FIG. 4. As shown in FIG. 5, the predetermined webpage W1-2 includes at least one file link corresponding to the program website address Wh1, such as two file links FL1 and FL2. Following that, this embodiment obtains source doe of the predetermined webpage W1-2, and parses the source doe of the predetermined webpage W1-2 to obtain the file links FL1 and FL2. When the file links FL1 and FL2 are obtained by analyzing the source code of the predetermined website W1-2, the relationship between the file links FL1 and FL2 can be analyzed first, and some keywords can be used for parsing. They analyzing approach is similar to that in step S120, and is not repeated herein.

After that, this embodiment enters the step S140, in which a play list is generated according to each program title and the at least one corresponding file link of each program title. The play list stores, for example, the relationship between each program title and its at least one corresponding file link. Referring to FIG. 6, which shows an example of the play list LIST which is generated according to an embodiment of this invention. In this exemplary play list LIST, the file links FL1 and FL2 corresponding to the program website address Mh1, obtained from the predetermined webpage W1-2 in FIG. 5, are placed in the following of the corresponding program title Mt1. Similarly, the at least one corresponding file link of each program website addresses Mh2-Mh10 can also be placed in the following of the program titles Mt2-Mt10, respectively. However, the play list LIST herein is provided for the purpose of illustration without any intention of limitation.

Next, as shown in the step S150, programs are played according to the play list, wherein each program corresponds to at least one multimedia files over the network. In an embodiment, when determining how to play the programs, multimedia files of the programs can be played according to the play list. For example, according to the play list LIST in FIG. 6, one program title (e.g. one of the program titles Mt1-Mt10 of the movie programs Mv1-Mv10) can be displayed, and each corresponding multimedia files of file links (e.g. file links FL1 and FL2) can be downloaded accordingly and played thereafter. In this way, if a multimedia file has been played, another multimedia file is played subsequently in this embodiment, thereby providing a series of programs belonging to the same category for a user, and increasing the convenience for the user.

Besides, in an embodiment, the multimedia play method further includes a step of receiving a play request, which is for selecting a corresponding channel of the mentioned play list LIST. The step S150 is, for example, performed after receiving the play request.

For example, the multimedia play method can store, in a channel list, the relationship between a number of play lists and a number of corresponding channels. The play request is, for example, from a remote control device. When the play request is to request a selection of a channel, this embodiment can search the channel list for the corresponding play list of the channel. In this way, when a channel is selected, this embodiment can provide corresponding program content according to the corresponding play list of the channel. Therefore, this embodiment allows a user to play programs of multimedia files with a similar way of operating television channels, thus increasing the convenience for the user.

Moreover, after receiving the play request, the multimedia play method further includes a step of receiving a switch request, which is for switching the played multimedia files. After that, the step S150 is, for example, performed by playing another multimedia file which is different from the currently played multimedia file according to the play list LIST.

For example, in the embodiment, when a play request is received to select a channel, and the step of playing programs is performed according to the corresponding play list LIST of the channel, the currently played multimedia file is stopped and a next multimedia file is played subsequently if the mentioned switch request is further received. Such a switching way is functioning as a “next” or “previous” function of a traditional video and audio player. As compared with traditional television channels, this embodiment allows a user to user a remote control device to switch the currently played programs, thereby further increasing the convenience for the user

According to the steps S110-5150, this embodiment can generate a play list from a number of multimedia files provided by a multimedia webpage, and use the play list to play programs when a corresponding channel is selected. Moreover, when the program content of the multimedia webpage is updated, such as the program titles, program website addresses, or file links, the embodiment can update the play list by performing the steps 5110-5150 again. Thus, the present embodiment can provide the user with updated program content, so as to provide a broad diversity of available programs.

Besides, an embodiment of this invention further provides computer readable storage medium, for storing a number of computer instructions. When an electronic device executes the computer instructions, electronic device performs the mentioned network-based multimedia play method.

Moreover, an embodiment of this invention further provides a computer program product, which is for performing a network-based multimedia play method in an electronic device having a buffer memory. The electronic device performs the network-based multimedia play method mentioned above when it loads and executes the computer program product. The computer readable storage medium of this embodiment includes, for example but without limitation to, an optical information storage medium or a magnetic information storage medium. The optical information storage medium may be CD, DVD, HD-DVD, blue-ray DVD or the like. The magnetic information storage medium may be a floppy disk drive, a hard disk drive, a magnetic tape drive, a magnetic optical drive or the like. In addition, the computer readable storage medium also includes program codes that can be transferred through the network/transmission media (e.g., air).

According to the present embodiments of the invention, the network-based multimedia play method and computer readable storage medium and computer program product thereof can generate a play list according to a multimedia webpage containing a number of programs, and determine how to play a number of multimedia files corresponding to the programs according to the play list. Therefore, if a multimedia file has been played, another multimedia file is played subsequently, thereby providing a series of programs belonging to the same category for a user, and increasing the convenience for the user.

While the disclosure has been described by way of example and in terms of a preferred embodiment, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A network-based multimedia play method for playing a number of programs, comprising the steps of:
obtaining a source code of a multimedia webpage;
parsing the source code of the multimedia webpage to obtain a number of program titles and a number of corresponding program website addresses;
obtaining at least one corresponding file link according to each program website address, wherein each file link is an access link of a multimedia file;
generating a play list according to each program title and the at least one corresponding file link of each program title; and
playing the programs according to the play list, wherein each program corresponds to at least one multimedia files over a network.

2. The network-based multimedia play method according to claim 1, wherein the step of parsing the source code of the multimedia webpage to obtain the program website addresses is performed according to a predetermined keyword.

3. The network-based multimedia play method according to claim 1, wherein the step of obtaining at least one corresponding file link according to each program website address comprises the step of:
decoding one program website address, so as to obtain the at least one corresponding file link of the program website address.

4. The network-based multimedia play method according to claim 3, wherein the step of decoding the program website address so as to obtain the at least one corresponding file link comprises the steps of:
transmitting the program website address to a predetermined website, the predetermined website generating a predetermined webpage after decoding the program website address, the predetermined webpage containing the at least one corresponding file link of the program website address;
obtaining another source code of the predetermined webpage; and
parsing the source code of the predetermined webpage to obtain the at least one file link.

5. The network-based multimedia play method according to claim 4, wherein the step of parsing the source code of the predetermined webpage is performed according to a predetermined keyword.

6. The network-based multimedia play method according to claim 3, wherein the step of decoding the program website address so as to obtain the at least one corresponding file link of the program website address is performed with a decode program.

7. The network-based multimedia play method according to claim 1, wherein the play list corresponds to a channel, and the method further comprises the step of:
receiving a play request, the play request being for selecting the channel;
wherein, in the step of playing the programs according to the play list, the multimedia files of the programs are displayed according to the play list when the play request is received.

8. The network-based multimedia play method according to claim 7, further comprises, after the step of receiving the play list, the step of:
receiving a switch request, the switch request being for switching the played multimedia files;
wherein, in the step of playing the programs according to the play list, another multimedia file which is different from the currently played multimedia file is played according to the play list.

9. The network-based multimedia play method according to claim 7, wherein the play request is from a remote control device.

10. A computer readable storage medium for storing a plurality of computer instructions, wherein when an electronic device executes the computer instructions, the electronic device performs the network-based multimedia play method according to claim 1.

11. A computer readable storage medium, which is for performing a network-based multimedia play method in an electronic device having a buffer memory, wherein when the electronic device performs the network-based multimedia play method according to claim 1 when the electronic device loads and executes the computer program product.
